(19) United States
(12) Patent Application Publication
(10) Pub. No.: US 2025/0382717 A1
(43) Pub. Date: Dec. 18, 2025

(54) FACILITY AND METHOD FOR PRODUCING HYDROGEN BY WATER ELECTROLYSIS

(71) Applicant: TECHNIP ENERGIES FRANCE, Nanterre CEDEX (FR)

(72) Inventors: Thibault DE SORBIER, NANTERRE CEDEX (FR); Anne-Sophie VAN-INGHELANDT, NANTERRE CEDEX (FR); Marc SELLINI, NANTERRE CEDEX (FR)

(21) Appl. No.: 18/879,126

(22) PCT Filed: Jun. 26, 2023
(86) PCT No.: PCT/EP2023/067235

§ 371 Date: Dec. 26, 2024

(30) Foreign Application Priority Data
Jun. 27, 2022 (FR) FR2206364

(51) Int. Cl. C25B 15/08; C25B 1/04; C25B 9/73

(52) U.S. Cl. CPC C25B 15/08; C25B 1/04; C25B 9/73

(57) ABSTRACT

A facility for producing hydrogen comprising:
A series of n electrolysers configured to electrolyze water and generate a hydrogen-aqueous solution mixture, said series having an overall capacity greater than 40 MW;
A gas-liquid separation device configured to remove the aqueous solution contained in the hydrogen-aqueous solution mixture generated by the series of n electrolysers, and produce a hydrogen stream; and
n lines configured to deliver the hydrogen-aqueous solution mixture generated by the n electrolyzers to the gas-liquid separation device.

The present invention relates to an installation for producing hydrogen by electrolysis of water and to a process for producing hydrogen using said installation.

It applies in particular, but not exclusively, to the supply of hydrogen with a view to its storage, for example in pressurized form, or to its use in a unit, of the refinery type, for transforming hydrogen into another vector chemicals such as methanol, ammonia, or fuels (such as sustainable aviation fuel SAF) or for export to a pipeline system, or for consumption as fuel gas in a fuel cell or in a burner.

We know the need to reduce our production of greenhouse gases and to use renewable energies. Hydrogen is an alternative to hydrocarbons because it is an easily storable source of energy, unlike electricity, and its oxidation releases a very high amount of energy (285 KJ/mole). Several ways of producing hydrogen are known; the most advantageous consists of electrolysing the water molecule because it is a high-yield reaction that does not produce CO2, unlike the massively used processes such as the reforming of methane and hydrocarbons.

Electrolysis units are currently made up of a certain number of modules, wherein electrolysis takes place, as well as a large number of equipment enabling it to operate correctly: electrolyzers, separation drums, pumps, gas coolers, liquids, pipes, instrumentation, etc. Large-capacity electrolysis production facilities are therefore designed using a modular approach: a large number of small electrolysis units are placed side by side, in other words in parallel, until the quantity desired electrolysis. This results in a very large number of equipment which generates:
An increase in HSE (Health-Safety-Environment) risks, in particular linked to the risks of explosion due to the presence of hydrogen;
An increase in the size of the installation and the floor occupation of the installation, in particular due to the safety distances to be respected between the various equipment but also between the equipment and the external environment; and
A significant increase in the price of the installation.

Starting from there, a problem which arises is to provide an improved installation for the production of hydrogen by electrolysis of water, in other words an installation having a reduced number of pieces of equipment.

A solution of the present invention is a hydrogen production facility comprising:
A series of n electrolyzers 4 configured to electrolyze water 1 and generate a hydrogen-aqueous solution mixture 5, said series having an overall capacity greater than 40 MW,
A gas-liquid separation device 8 configured to remove the aqueous solution contained in the hydrogen-aqueous solution mixture 5 generated by the series of n electrolysers 4, and produce a flow of hydrogen 9, and
n lines 7 configured to supply the hydrogen-aqueous solution mixture generated by the n electrolysers 4 to the gas-liquid separation device 8.

In other words, in the solution according to the invention a single gas-liquid separation device configured to eliminate the solution aqueous (or water comprising up to approximately 40% by mass of salts; the salts preferably being potassium hydroxide) contained in the hydrogen-aqueous solution mixture is associated with n water electrolysis modules.

Preferably, each electrolyzer consists of a stack of several electrolysis cells which can most probably be of the alkaline or PEM type (proton exchange membrane) connected in series, which is commonly called a stack. The stack is supplied with direct current by an electrical distribution system whose output voltage can be adjustable. Other types of electrolysis cells can be used, such as AEM cells (anion exchange membrane), SOECs (solid oxide electrolysis cells), PCECs (protonic ceramic electrochemical cells). More generally, any type of electrolyser can be used.

By “overall capacity” of the series of n electrolysers, we mean the accumulation of the n capacities of the n electrolyzers.

Preferentially, the series of n water electrolysis modules will have an overall capacity greater than 100 MW, or even greater than several hundred MW.

Typically, for an electrolysis capacity of approximately 5 MW per stack, “n” may be between 8 and 200, preferably between 16 and 40.

The term “lines” means a set of pipes, pumps and valves.

It goes without saying that the series of n electrolysis modules of water generates oxygen in addition to hydrogen. Also advantageously, the installation will comprise a second gas-liquid separation device configured to eliminate the aqueous solution (or water comprising up to approximately 40% by mass of salts) contained in the oxygen-aqueous solution mixture generated by the series of n electrolyzers. There will therefore also be n lines 13 configured to supply the oxygen-aqueous solution mixture generated by the n electrolysers to the second gas-liquid separation device 14. The oxygen 15 recovered at the outlet of the second gas-liquid separation device will then be cooled in a cooler 16 at a temperature between 30 and 40° C., then collected in a collection system 19 or will more generally be sent to the atmosphere.

The water can be stored in a storage tank connected to the water supply circuit upstream of the series of n electrolysers. The water supply circuit can be connected to running water and has several water purification units, which can be of different types (e.g., resin and/or activated carbon) for better purification. For example, a conductivity sensor mounted on the water supply circuit makes it possible to continuously check the degree of purity of the water. The use of analyzers can also make it possible to monitor the level of salt impurity in the purified water.

The installation according to the invention may comprise loops for recycling the aqueous solution between the gas-liquid separation devices and the series of n electrolysers. Advantageously, each recycling loop will include a cooler in order to cool the aqueous solution to a temperature lower than that of the electrolyzers, preferably to a temperature of between 50 and 80° C., even more preferably to a temperature of between 60 and 70° C.

At the outlet of the installation according to the invention, the hydrogen and the oxygen are led to extraction circuits. As a safety measure, these extraction circuits may be provided with gas evacuation means, for example valves or vents, intended to instantly lower the pressure in the event of overpressure or explosion or fire.

Depending on the case, the installation according to the invention may

have one or more of the characteristics below:
the gas-liquid separation device 8 is connected to a capacity greater than 40 MW, preferably greater than 100 MW;
the gas-liquid separation device 8 has a hydrogen inventory H of less than or equal to 0.7 nh with:
n the number of electrolysers and,
h the hydrogen inventory in each gas-liquid separation device configured to eliminate the aqueous solution contained in the hydrogen-aqueous solution mixture, for an installation of similar capacity to the installation according to the invention and comprising n associated electrolysers in series with n gas-liquid separation devices configured to remove the aqueous solution contained in the hydrogen-aqueous solution mixture;
“inventory” means the volume of hydrogen accumulated in the gas-liquid separation device; it is usually expressed in m³ (cubic meter)
the gas-liquid separation device 8 is made of a material chosen from among carbon steel, stainless steel, duplex steel, nickel, electroless nickel, or carbon steel with nickel coating.
the gas-liquid separation device 8 is a separating drum, which can contain a separation internal; preferably the separating balloon will be a horizontal balloon. Indeed, a horizontal balloon has the advantage of having a larger gas/liquid exchange surface while having a smaller diameter than a vertical balloon. In certain cases, and more particularly when the operating pressure is low, it is possible to envisage a vertical separator;
the series of n electrolysers 4 is included in at least one closed building B and the gas-liquid separation device 8 is located outside this building B; the size of building B is thus reduced;
the lines 7, and preferably the associated valves, are located at least largely outside the building B; this also makes it possible to reduce the size of the building B and to limit the risks of hydrogen leakage in the building B. Furthermore, by placing the valves outside of the building B their accessibility is facilitated.
the installation comprises a cooler 10 configured to cool the hydrogen 9 leaving the gas-liquid separation device 8; in other words, a single cooler is associated with the single gas-liquid separation device 8; the cooler can be a Peltier effect gas cooler, but more generally a plate exchanger or a tubular exchanger.
The installation comprises a unit 11 for purifying the flow of hydrogen leaving the cooler 10; The impurities to be eliminated are mainly oxygen and water, as well as some traces of salts, etc. The purification unit 11 can be chosen from: a water washing unit allowing the elimination of salts (for example potassium hydroxide), a cooler coupled or not to the water washing unit and allowing the flow to be cooled to a temperature between 30 and 40° C., a catalytic deoxygenation unit, and a drying unit (for example drying by cooling allowing the flux to be cooled to a temperature between 5 and 10° C. or drying on a molecular sieve). Preferably, these different units will be added in series to the installation. It should be noted that the water recovered at the drying outlet can be recycled in the series of n electrolysers. An analysis unit may be placed downstream of this (these) purification unit(s) in order to check the residual concentration of impurities in the hydrogen flow.
the installation comprises a hydrogen flow compression unit downstream of purification unit 11. The type of compressor can be reciprocating, centrifugal or mainly membrane; Note that a compression unit can also be placed upstream of the purification unit 11;
the installation comprises a static mixer configured to mix the hydrogen from the n lines upstream of the gas-liquid separation device.

The static mixer makes it possible to have homogeneous bubble sizes and thus to have an easier separation in the gas-liquid separation device.

The present invention also relates to a process for producing hydrogen implementing an installation according to the invention and comprising:
a) A water electrolysis step to generate a hydrogen-aqueous solution mixture 5 using a series of n electrolysers 4 with an overall capacity greater than 40 MW,
b) A step of conveying the hydrogen-aqueous solution mixture 5 generated in step a) to the gas-liquid separation device 8 via the n lines 7, and
c) A gas-liquid separation step making it possible to eliminate the aqueous solution contained in the hydrogen-aqueous solution mixture 5 generated in step a) by means of the gas-liquid separation device 8.

Depending on the case, the method according to the invention may exhibit one or more of the characteristics below:
step c) is carried out at a temperature between 60 and 100° C.
step c) is carried out at a pressure of between 1 and 70 bar, preferably between 1 and 41 bar.
The method comprises a step d) of cooling the hydrogen resulting from step c) to a temperature between 30 and 40° C.
The process comprises a step e) of purification of the hydrogen cooled in step d).
The process comprises a step f) of compressing the hydrogen resulting from step e) at a pressure greater than the pressure of the gas-liquid separation device 8, preferably at a pressure of between 20 and 60 bar. Depending on the uses and in particular mobility applications, a compression step at several hundred bars is necessary.
The method comprises between steps b) and c) a step of homogenizing the flow of hydrogen.

Since oxygen is also generated in step a), the method according to the invention will preferably comprise a step of conveying the oxygen-aqueous solution mixture 6 generated in step a) to the second gas-liquid separation device via the dedicated n lines 13 and a gas-liquid separation step 14 making it possible to eliminate the aqueous solution contained in the oxygen-aqueous solution mixture 6 generated in step a) by means of the gas-liquid separation device 14. As indicated previously, the oxygen 15 recovered at the outlet of the second gas-liquid separation device will then be cooled in the cooler 16 to a temperature between 30 and 40° C., then collected in a collection system 19 or will more generally be sent to the atmosphere.

Advantageously, the method according to the invention will comprise a step of recycling the aqueous solutions from the gas-liquid separation devices 8 and 14 to the electrolysers 4, preferably after cooling the aqueous solutions to a temperature between 50 and 80° C., even more preferentially at a temperature of between 60 and 70° C.

In other words, if we do not take into account any coolers that could be used in the purification step 11, the installation does not include 3n coolers as is taught in the prior art but only three coolers:
a cooler 10 configured to cool the hydrogen 9 leaving the gas-liquid separation device 8;
a cooler 16 configured to cool the oxygen 15 leaving the gas-liquid separation device 14; and
a cooler configured to cool the aqueous solutions from the gas-liquid separation devices 8 and 14.

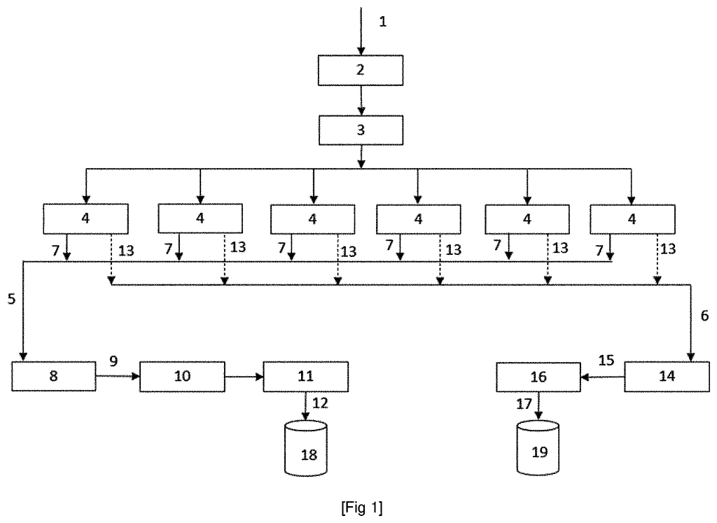

The installation will now be described in more detail with the aid of FIG. 1.

The water 1 coming from a supply or from a storage tank 2 is introduced into a water treatment unit 3 (by water treatment is preferentially meant demineralization and deionization). The purified water is then injected into the circuit of aqueous solution to then be electrolysed in a series of n electrolysers 4 (stacks), said series having an overall capacity greater than 40 MW. Leaving the series of n electrolysers 4, a hydrogen-aqueous solution mixture 5 and an oxygen-aqueous solution mixture 6 are recovered. The hydrogen-aqueous solution mixture 5 is conveyed via n lines 7 to the first gas-liquid separation device 8 configured to eliminate the aqueous solution contained in the hydrogen-aqueous solution mixture generated by the series of n electrolyzers 4. The flow of hydrogen 9 leaving the gas-liquid separation device 8 is saturated with water. The hydrogen stream 9 is generally cooled to a temperature of between 40 and 30° C. in a cooler 10 before being introduced into a purification unit 11. The hydrogen stream 12 leaving the purification unit 11 has a purity greater than 99.99%, preferably greater than 99.999%. The hydrogen stream 12 may optionally be compressed to a pressure greater than that at the inlet in the purification unit 11, preferably greater than 15 bar before being stored 18 or conveyed to an extraction circuit.

The oxygen-aqueous solution mixture 6 is conveyed via n lines 13 to the second gas-liquid separation device 14 configured to eliminate the aqueous solution contained in the oxygen-aqueous solution mixture 6 generated by the series of n electrolysers 4. The oxygen stream 15 leaving the second gas-liquid separation device 14 is saturated with water. Oxygen stream 15 is cooled to a temperature between 40 and 30° C. in cooler 16. The oxygen stream 17 leaving cooler 16 has a purity greater than 98%, preferably greater than 99%; it will be stored in a collection system 19 or routed to an extraction circuit.

Finally, the present invention also relates to a process for manufacturing the hydrogen production installation according to the invention, characterized in that it comprises:
i) a step for determining the hydrogen inventory h in each gas-liquid separation device configured to eliminate the aqueous solution contained in the hydrogen-aqueous solution mixture, for an installation of similar capacity to the installation according to the invention and comprising n electrolyzers associated in series with n gas-liquid separation devices configured to eliminate the aqueous solution contained in the hydrogen-aqueous solution mixture;
ii) a step of sizing the gas-liquid separation device 8 of the installation according to the invention so that said gas-liquid separation device 8 has an inventory H of less than nh, preferably less than 70% nh.

In other words, the gas-liquid separation device 8 will have a lower hydrogen inventory than a set of n gas-liquid separation devices of the same overall capacity. This results in a reduced HSE risk.

Preferably, the manufacturing method according to the invention also comprises a step of installing the electrolyzers in at least one building B (several buildings can be built to house the n electrolysers) and a step of manufacturing, preferentially on site, the device for gas-liquid separation 8 outside building B. By “preferentially on site” is meant that the gas-liquid separation device can be manufactured by assembling all the equipment on site as opposed to a “modular assembly”, which corresponds the installation of one or more skids, manufactured outside the site. It should be noted that “by manufacturing outside” is meant manufacturing on site outside of the building(s) B.

The installation according to the invention does not include “n” gas-liquid separation devices configured to eliminate the aqueous solution contained in the hydrogen-aqueous solution mixture generated by the series of n electrolysers 4, as proposed in the prior art, but comprises a single gas-liquid separation device 8 configured to eliminate the aqueous solution contained in the hydrogen-aqueous solution 5 generated by the series of n electrolyzers 4. In other words, the solution according to the invention makes it possible to:
reduce the number of equipment;
limit HSE (Health-Safety-Environment) risks by reducing devices that accumulate hydrogen;
reduce the size of the installation and the floor occupation. Indeed, by reducing the number of equipment, the safety distances are also reduced; and
reduce the cost of installation.

It should be noted that the size of the installation and the cost of the installation are also minimized by the reduction in the number of pieces of equipment: a single gas-liquid separation device 8 configured to eliminate the aqueous solution contained in the hydrogen-solution mixture aqueous 5, a single gas-liquid separation device 14 configured to eliminate the aqueous solution contained in the oxygen-aqueous solution mixture 6, only three coolers (the cooler 10 configured to cool the hydrogen 9 leaving the gas-liquid separation device 8, the cooler 16 configured to cool the oxygen 15 leaving the gas-liquid separation device 14 and the cooler of the loop for recycling the aqueous solution), a number of pumps which has been divided by 5 compared to the installations of the prior art, not to mention the reduction in the number of pipes. By “installations of the prior art” is meant installations which comprise n electrolyzers, n gas-liquid separation devices configured to eliminate the aqueous solution contained in the hydrogen-aqueous solution mixture, n gas-liquid separation devices configured to eliminate the aqueous solution contained in the oxygen-aqueous solution mixture, 3n coolers, as well as the associated number of pumps (typically about fifteen) and pipes. Also, if the total number of equipment items is counted, it will be noted that this has been divided at least by three in the installation according to the invention. From there, compared to an installation according to the prior art, the installation according to the invention has a building B whose height has been reduced by at least 25%, and whose footprint on the ground has been divided between 2 and 5 times. This has the consequence in particular of an easier renewal of air in the building. Regarding the overall footprint on the ground (footprint on the ground of the building and other equipment including gas-liquid separation devices) this has also been reduced by 10 to 30%.

1. A hydrogen production facility comprising:
A series of n electrolysers configured to electrolyze water and generate a hydrogen-aqueous solution mixture, said series having an overall capacity greater than 40 MW,
A gas-liquid separation device configured to remove the aqueous solution contained in the hydrogen-aqueous solution mixture generated by the series of n electrolysers, and produce a hydrogen flow, and
n lines configured to supply the hydrogen-aqueous solution mixture generated by the n electrolyzers to the gas-liquid separation device.

2. The installation according to claim 1, wherein the gas-liquid separation device-is connected to a capacity greater than 40 MW, preferably greater than 100 MW.

3. The installation according to claim 1, wherein the gas-liquid separation device has a hydrogen inventory H of less than or equal to 0.7 nh with:
n the number of electrolyzers and,
h the hydrogen inventory in each gas-liquid separation device configured to eliminate the aqueous solution contained in the hydrogen-aqueous solution mixture, for an installation of similar capacity to the installation according to the invention and comprising n associated electrolysers in series with n gas-liquid separation devices configured to remove the aqueous solution contained in the hydrogen-aqueous solution mixture.

4. The installation according to claim 1, wherein the gas-liquid separation device-is made of a material chosen from among carbon steel, stainless steel, duplex steel, nickel, nickel electroless, or carbon steel with nickel coating.

5. The installation according to claim 1, wherein the gas-liquid separation device is a separator drum, preferably a horizontal separator drum.

6. The installation according to claim 1, wherein the series of n electrolyzers is included in at least one closed building B and the gas-liquid separation device-is located outside this building B.

7. The installation according to claim 6, wherein the lines are located at least partly outside the building B

8. The installation according to claim 1, wherein the hydrogen production facility further comprises a cooler configured to cool the hydrogen leaving the gas-liquid separation device.

9. The installation according to claim 1, wherein the hydrogen production facility further comprises a static mixer configured to homogenize the hydrogen-aqueous solution mixture upstream of the gas-liquid separation device.

10. A process for the production of hydrogen implementing an installation as defined in claim 1and comprising:
a) a water electrolysis step to generate a hydrogen-aqueous solution mixture using a series of n electrolyzers with an overall capacity greater than 40 MW,
b) a step for conveying the hydrogen-aqueous solution mixture-generated in step a) to the gas-liquid separation device-via the n lines, and
c) a gas-liquid separation step making it possible to eliminate the aqueous solution contained in the hydrogen-aqueous solution mixture generated in step a) by means of the gas-liquid separation device.

11. The production process according to claim 10, characterized in thatwherein step c) is carried out at a temperature of between 60 and 100° C.

12. The production process according to claim 10, wherein step c) is carried out at a pressure of between 1 and 40 bar.

13. The production process according to claim 10, wherein the hydrogen production facility further comprises a step d) of cooling the hydrogen resulting from step c) to a temperature of between 30 and 40° C.

14. The process for manufacturing the hydrogen production installation as defined in claim 1, wherein the hydrogen production facility further comprises:
i) a step for determining the hydrogen inventory h in each gas-liquid separation device configured to eliminate the aqueous solution contained in the hydrogen-aqueous solution mixture, for an installation of similar capacity to the installation as defined in claim 1 and comprising n electrolysers associated in series with n gas-liquid separation devices configured to remove the aqueous solution contained in the hydrogen-aqueous solution mixture;
ii) a step of sizing the gas-liquid separation device of the installation as defined in claim 1 so that said gas-liquid separation device has a lower inventory H to nh, preferably less than 70% nh.

15. The manufacturing process according to claim 14, wherein the hydrogen production facility further comprises a step of installing the electrolysers in at least one building B and a step of manufacturing, preferably on site, the gas-liquid separation device-at the exterior of building B.
